(19) United States
(12) Patent Application Publication
(10) Pub. No.: US 2022/0022383 A1
(43) Pub. Date: Jan. 27, 2022

(54) COMBINED VERTICAL GREENING DEVICE

(71) Applicant: SHENZHEN CUILU TECHNOLOGY GREENING ENGINEERING CO., LTD., Shenzhen, Guangdong (CN)

(72) Inventor: Feng LI, Shenzhen, Guangdong (CN)

(21) Appl. No.: 17/297,053

(22) PCT Filed: Aug. 7, 2020
(86) PCT No.: PCT/CN2020/107607

§ 371 Date: May 26, 2021

(51) Int. Cl. A01G 9/02

(52) U.S. Cl. CPC A01G 9/023

(57) ABSTRACT

A combined vertical greening device includes a first flowerpot and a second flowerpot. Each of a left side wall and a right side wall of the first flowerpot is fixedly provided with a first connecting plate; and two second connecting plates are fixedly arranged on the rear side wall of the first flowerpot. Each of a left side wall and a right side wall of the second flowerpot is fixedly provided with a third connecting plate at corresponding side wall of the first flowerpot, and fourth connecting plates corresponding to the respective second connecting plates are fixedly arranged on the rear side wall of the second flowerpot. The combined vertical greening device has a simple structure and long service life, and is easy to install and maintain.

### CROSS REFERENCE TO RELATED APPLICATION

This application claims the priority of Chinese Patent Application No. 201910758371.9, entitled “Combined Vertical Greening Device” filed with the Chinese Patent Office on Aug. 16, 2019 which is incorporated herein by reference in its entirety.

### TECHNICAL FIELD

The present disclosure relates to the technical field of flower and grass planting apparatus, in particular to a combined vertical greening device.

### BACKGROUND ART

With the continuous acceleration of the urbanization trend, the construction of a large number of artificial environments and a series of resulting negative effects such as environmental pollution have brought survival crisis to mankind, restrict social and economic development, and also seriously affect the survival and development of the city itself. Urban greening as an infrastructure construction industry in cities and an indispensable and important part of urban environmental construction plays an important role in promoting the implementation of urban sustainable development strategies. Therefore, with the rapid development of urban construction, people must consider the simultaneous improvement of urban greening. Continuously increasing the green area of the city is an important means to improve the urban environment. Traditional greening model is far from meeting the needs of the new form. Three-dimensional greening is an effective way to solve this problem.

However, traditional three-dimensional greening is generally to arrange a long box with drainage holes on the back of the long box, and then fix the whole box on a wall or shelf for three-dimensional greening. For a greening project of a relatively large area, the box has relatively high cost, and is not conducive to the assembly of patterns, and the installation procedure of the box is also relatively complicated. Most of the greening boxes are welded together. When one of the boxes needs to be replaced or maintained, the entire three-dimensional greening box should be taken down, which is not conducive to replacement and maintenance. In terms of irrigation, each flowerpot is independent and needs to be irrigated independently, which causes much inconvenience in the later maintenance and management process. Moreover, the substrate in the flowerpot is prone to leak out when the flowerpot is placed horizontally. In terms of materials, most of three-dimensional greening flowerpots or related components are made of plastic, and therefore, in the process of use, the poor durability causes wasting of resources and high operating cost.

### SUMMARY

The object of some embodiments is to provide a combined vertical greening device for solving problems described above in the prior art, the combined vertical greening device has a simple structure and long service life and is easy to install and maintain. In order to achieve the purposes described above, the present disclosure provides the following technical solution:

the present disclosure provides the combined vertical greening device, the combined vertical greening device includes a first flowerpot and a second flowerpot. Each of a left side wall and a right side wall of the first flowerpot is fixedly provided with a first connecting plate; and two second connecting plates are fixedly arranged on the rear side wall of the first flowerpot. Bottom end of each first connecting plate and bottom ends of the second connecting plates protrude from a bottom end of the first flowerpot. Each of a left side wall and a right side wall of the second flowerpot is fixedly provided with a third connecting plate corresponding to the first connecting plate, and fourth connecting plates corresponding to the respective second connecting plates are fixedly arranged on the rear side wall of the second flowerpot. A top end of each third connecting plate and top ends of the fourth connecting plates protrude from a top end of the second flowerpot. The bottom end of each first connecting plate is corresponding fixedly connected to the top end of the corresponding third connecting plate. The bottom end of each second connecting plate is fixedly connected to the top end of corresponding fourth connecting plate; a water inlet, a drainage hole and a overflow hole are formed in the rear side wall of each of the first flowerpot and the second flowerpot; and horizontal net racks are arranged both in the first flowerpot and the second flowerpot.

Preferably, the first connecting plates, the second connecting plates, the third connecting plates and the fourth connecting plates are all vertical. A first transverse steel plate is arranged inside the rear side wall of the first flowerpot, one end of the first transverse steel plate is fixedly connected to one of the second connecting plates, and other end of the first transverse steel plate is fixedly connected to other one of the second connecting plates. A second transverse steel plate is arranged inside the rear side wall of the second flowerpot, one end of the second transverse steel plate is fixedly connected to one of the second connecting plates, and other end of the second transverse steel plate is fixedly connected to other one of the fourth connecting plates. Preferably, a front side wall of the first flowerpot is provided at an angle of 135 degrees with the bottom surface of the first flowerpot, and a front side wall of the second flowerpot is provided at an angle of 135 degrees with the bottom surface of the second flowerpot.

Preferably, the first flowerpot and the second flowerpot are both formed by pouring of reactive powder concrete; the first connecting plates and the second connecting plates are all partially cast in the first flowerpot; the second connecting plates and the fourth connecting plates are all partially cast in the second flowerpot; a plurality of through holes are formed in each of parts of the first connecting plates and the second connecting plates, which are located in the first flowerpot; a circular hole corresponding to the water inlet of the first flowerpot is formed in one of the second connecting plates; a circular hole corresponding to the drainage hole of the first flowerpot is formed in other one of the second connecting plates; a plurality of through holes are formed in each of parts of the third connecting plates and the fourth connecting plates, which are located in the second flowerpot; a circular hole corresponding to the water inlet of the second flowerpot is formed in one of the fourth connecting plates; and a circular hole corresponding to the drainage hole of the second flowerpot is formed in other one of the fourth connecting plates.

Preferably, the bottom end of the first connecting plate is fixedly connected to the top end of the corresponding third connecting plate through a first connecting block; the first connecting plate and the third connecting plate are connected to the first connecting block respectively by bolts; the bottom end of each of the second connecting plates is fixedly connected to the top end of corresponding one of the fourth connecting plates through a second connecting block; and the each of second connecting plates and the corresponding one fourth connecting plate are connected to the second connecting block respectively by bolts.

Preferably, the first connecting plates, the second connecting plates, the third connecting plates and the fourth connecting plates are all steel plates, and the first connecting blocks and the second connecting blocks are all steel blocks.

Preferably, the thicknesses of the left side wall, right side wall, rear side wall of the first flowerpot and the thicknesses of the left side wall, right side wall and rear side wall of the second flowerpot are all 20 mm; the thickness of the front side wall of the first flowerpot and the thickness of the front side wall of the second flowerpot are both 10 mm; and the thicknesses of the first connecting plates, the second connecting plates, the third connecting plates and the fourth connecting plates are all less than or equal to 5 mm.

Preferably, the diameter of each overflow hole is 10 mm; the distance between the net rack in the first flowerpot and a inner bottom surface of the first flowerpot is 50 mm, the distance between the overflow hole in the first flowerpot and the bottom end of the first flowerpot is 100 mm, the distance between the net rack in the second flowerpot and a inner bottom surface of the second flowerpot is 50 mm, and a distance between the overflow hole in the second flowerpot and the bottom end of the second flowerpot is 100 mm.

Compared with the prior art, the combined vertical greening device achieves the following technical effects: the combined vertical greening device has a simple structure and long service life and is easy to install and maintain; the combined vertical greening device only includes two independent flowerpots and a plurality of steel plates for connection, and has a simple structure and low cost; the flowerpot is formed by pouring of reactive powder concrete, has good durability and long service life, and is not easy to damage; the arrangement of the net rack in the flowerpot can ensure that the roots of plants are prevented from being soaked on the basis of growing downward; and the combined vertical greening device can be massively produced and is convenient for large-scale popularization and application.

### BRIEF DESCRIPTION OF THE DRAWINGS

In order to illustrate the embodiments of the present disclosure or the technical solution in the prior art more clearly, the drawings needed in the embodiments are briefly introduced below. Obviously, the drawings in the following description are only some embodiments of the present disclosure. Other drawings can be obtained based on these drawings by those ordinarily skilled in the art without paying creative work.

FIG. 1 is a structure diagram of a combined vertical greening device according to the present disclosure;

FIG. 2 is a rear view of the combined vertical greening device according to the present disclosure;

FIG. 3 is an A-A section view of FIG. 2.

In the drawings: 1 first flowerpot, 101 first connecting plate, 102 second connecting plate, 103 first water inlet, 104 first drainage hole, 105 first overflow hole, 2 second flowerpot, 201 third connecting plate, 202 fourth connecting plate, 203 second water inlet, 204 second drainage hole, 205 second overflow hole, 3 first connecting block, 4 second connecting block.

### DETAILED DESCRIPTION OF THE EMBODIMENTS

The technical solution in the embodiments of the present disclosure is described clearly and completely in conjunction with the drawings in the embodiments of the present disclosure. Obviously, the described embodiments are merely a part of the embodiments of the present disclosure and not all the embodiments. Based on the embodiments of the present disclosure, other embodiments obtained by those ordinarily skilled in the art without paying creative work all fall within the protection scope of the present disclosure.

The purpose of some embodiments is to provide a combined vertical greening device for solving problems in the prior art, the combined vertical greening device has a simple structure and long service life and is easy to install and maintain.

In order to make the purpose, characteristics and advantages of the present disclosure described above more obvious and understandable, the present disclosure is further illustrated in detail below with reference to drawings and specific implementations.

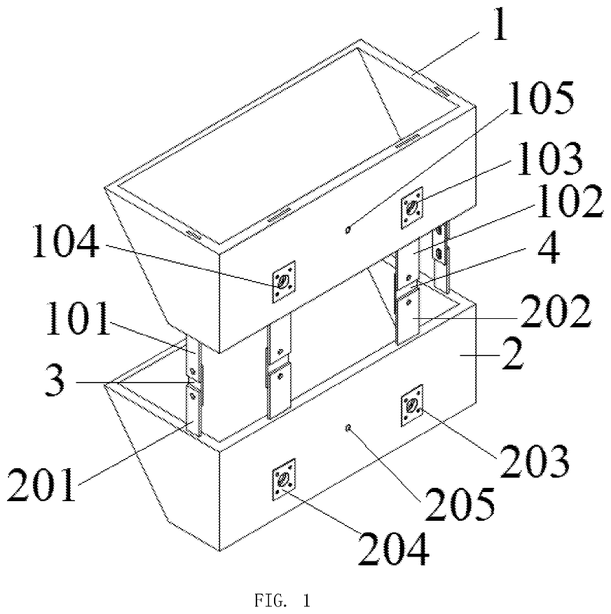

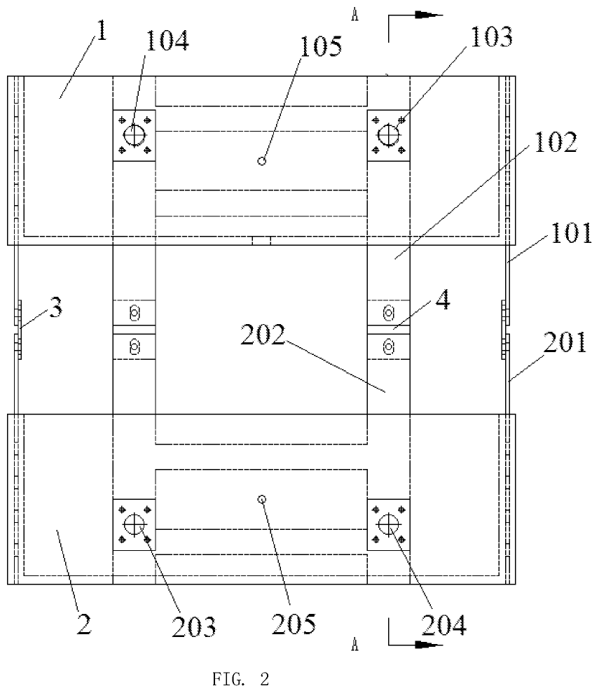

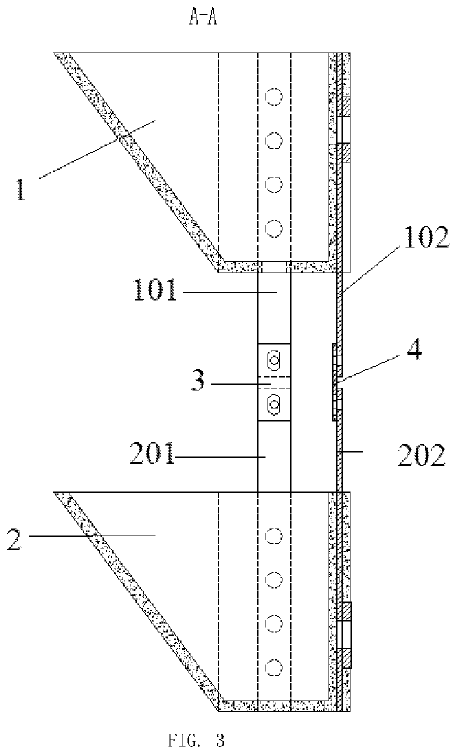

As shown in FIG. 1 to FIG. 3, an embodiment provides a combined vertical greening device. The combined vertical greening device includes a first flowerpot 1 and a second flowerpot 2. Each of a left side wall and a right side wall of the first flowerpot 1 is fixedly provided with a first connecting plate 101, and two second connecting plates 102 are fixedly arranged on the rear side wall of the first flowerpot 1. Bottom end of each first connecting plate 101 and bottom ends of the second connecting plates 102 protrude from a bottom end of the first flowerpot 1. Each of a left side wall and a right side wall of the second flowerpot 2 is fixedly provided with a third connecting plate 201 corresponding to the first connecting plate 101, and fourth connecting plates 202 corresponding to the respective second connecting plates 102 are fixedly arranged on the rear side wall of the second flowerpot 2. A top end of each third connecting plate 201 and top ends of the fourth connecting plates 202 protrude from a top end of the second flowerpot 2. The bottom end of each first connecting plate 101 is fixedly connected to the top end of the corresponding third connecting plate 201 through a first connecting block 3, and the first connecting plate 101 and the third connecting plate 201 are connected to the first connecting block 3 respectively by bolts, The bottom end of each second connecting plate 102 is fixedly connected to the top end of corresponding fourth connecting plate 202 through a second connecting block 4, and the second connecting plate 102 and the fourth connecting plate 202 are connected to the second connecting block 4 respectively by bolts. In the embodiment, the first connecting plates 101, the second connecting plates 102, third connecting plates 201 and the fourth connecting plates 202 are all steel plates, and the first connecting block 3 and the second connecting blocks 4 are all steel blocks.

The first connecting plates 101, the second connecting plates 102, the third connecting plates 201 and the fourth connecting plates 202 are all vertical. A first transverse steel plate is arranged inside the rear side wall of the first flowerpot 1, one end of the first transverse steel plate is fixedly connected to one of the second connecting plates 102, and other end of the first transverse steel plate is fixedly connected to other one of the second connecting plates 102. A second transverse steel plate is arranged inside the rear side wall of the second flowerpot 2, one end of the second transverse steel plate is fixedly connected to one of the fourth connecting plates 202, and other end of the second transverse steel plate is fixedly connected to other one of the fourth connecting plates 202.

The first flowerpot 1 and the second flowerpot 2 are both formed by pouring of reactive powder concrete. Upper parts of the first connecting plates 101, the upper parts of the second connecting plates 102, and the first transverse steel plate are integrally cast in the first flowerpot 1, and the lower parts of the second connecting plates 102, the lower parts of the fourth connecting plates 202, and the second transverse steel plate are integrally cast in the second flowerpot. A plurality of through holes are formed in each of parts of the first connecting plates 101 and the second connecting plates 102, which are located in the first flowerpot 1, and a plurality of through holes are formed in each of parts of the third connecting plates 201 and the fourth connecting plates 202, which are located in the second flowerpot 2. Configuration of the first connecting plates 101, the second connecting plates 102, the third connecting plates 201 and the fourth connecting plates 202 can ensure a good bonding effect of the first connecting plates 101, the second connecting plates 102, the third connecting plates 201 and the fourth connecting plates 202 with concrete in the flowerpot.

A first water inlet 103, a first drainage hole 104 and a first overflow hole 105 are formed in the rear side wall of the first flowerpot 1, and a second water inlet 203, a second drainage hole 204 and a second overflow hole 205 are formed in the rear side wall of the second flowerpot 2. A circular hole corresponding to the first water inlet is formed in the second connecting plate 102 on the right, and a circular hole corresponding to the first drainage hole is formed in the second connecting plate 102 on the left. A circular hole corresponding to the second water inlet is formed in the fourth connecting plate 202 on the right, and a circular hole corresponding to the drainage hole of the second flowerpot 2 is formed in the fourth connecting plate on the left. Particularly, the first flowerpot 1 is internally provided with a steel plate having a penetrating hole corresponding to the first water inlet 103 and the first drainage hole 104, and the second flowerpot 2 is internally provided with a steel plate having a penetrating hole corresponding to the second water inlet 203 and the second drainage hole 204. The diameters of the first overflow hole 105 and the second overflow hole 205 are both 10 mm, the distance between the first overflow hole 105 and the bottom end of the first flowerpot 1 is 100 mm, and a distance between the second overflow hole 205 and the bottom end of the second flowerpot 2 is 100 mm Horizontal net racks are arranged both in the first flowerpot 1 and the second flowerpot 2. The distance between the net rack in the first flowerpot 1 and a inner bottom surface of the first flowerpot 1 is 50 mm, and the distance between the net rack in the second flowerpot 2 and a inner bottom surface of the second flowerpot 2 is 50 mm. Water storage tanks are arranged under the net racks and provide necessary water source for roots of plants. The net racks are made of steel, and meshes of the net racks should be relatively dense to prevent the substrate of planting plants from falling into lower water.

A front side wall of the first flowerpot 1 is provided at an angle of 135 degrees with the bottom surface of the first flowerpot 1, and a front side wall of the second flowerpot 2 is provided at an angle of 135 degrees with the bottom surface of the second flowerpot 2. The front side walls of the first flowerpot 1 and the second flowerpot 2 are arranged slantwise to facilitate the growth of the plants toward the light, so as to obtain sufficient light source.

Since stress on the backs and side edges of the first flowerpot 1 and the second flowerpot 2 is relatively large and concentrated, the thicknesses of the left side wall, right side wall, and rear side wall of the first flowerpot 1 and the thicknesses of the left side wall, right side wall, and rear side wall of the second flowerpot 2 are all 20 mm. The stress on the front side walls of the first flowerpot 1 and the second flowerpot 2 is relatively small (mainly from the pressure of soil inside the flowerpot). In order to reduce the mass of the module, the thicknesses of the front side walls can be appropriately reduced. In the embodiment, the thickness of the front side wall of the first flowerpot 1 and the thicknesses of the front side wall of the second flowerpot 2 are both 10 mm. As too large thicknesses of the steel frame cause concrete protective layers on the outsides of the steel plates to be too thin, the durability of the flowerpot is affected, and therefore, the thicknesses of the first connecting plates 101, the second connecting plates 102, the third connecting plates 201 and the fourth connecting plates 202 in the embodiment are all less than or equal to 5 mm so as to ensure the durability of the first flowerpot 1 and the second flowerpot 2.

In the description of the present disclosure, it should be noted that the terms such as “top”, “bottom”, “left”, “right”, “vertical”, “horizontal”, “inside”, “outside” indicate the orientational or positional relationship based on the orientational or positional relationship shown in the drawings, the terms are only for the convenience of describing the present disclosure and simplifying the description, but do not indicate or imply that the pointed device or element must have a specific orientation, be constructed and operated in a specific orientation, and therefore, the terms cannot be understood as a limitation to the present disclosure. In addition, the terms such as “first” and “second” are only used for describing objects, and cannot be understood as indicating or implying relative importance.

In specification, specific examples are used to explain the principle and implementation of the present disclosure. The description of the above embodiment is only used to help understand the method and core idea of the present disclosure; meanwhile, the specific implementation and application scope may be changed by those ordinarily skilled in the art according to the idea of the disclosure. In summary, the content of the specification should not be understood as a limitation to the present disclosure.

1. A combined vertical greening device, comprising a first flowerpot and a second flowerpot, each of a left side wall and a right side wall of the first flowerpot is fixedly provided with a first connecting plate; a rear side wall of the first flowerpot is fixedly provided with two second connecting plates; a bottom end of the first connecting plate and bottom ends of the second connecting plates protrude from a bottom end of the first flowerpot; each of a left side wall and a right side wall of the second flowerpot is fixedly provided with a third connecting plate corresponding to the first connecting plate at corresponding side wall of the first flowerpot, a rear side wall of the second flowerpot is fixedly provided with fourth connecting plates corresponding to the respective second connecting plates; a top end of the third connecting plate and top ends of the fourth connecting plates protrude from a top end of the second flowerpot; the bottom end of the first connecting plate is fixedly connected to the top end of the third connecting plate at corresponding side wall of the second flowerpot; the bottom ends of the second connecting plates are fixedly connected to the respective top ends of the respective fourth connecting plates; a water inlet, a drainage hole and an overflow hole are formed in each of the rear side wall of the first flowerpot and the rear side wall of the second flowerpot; and a horizontal net rack is arranged in each of the first flowerpot and the second flowerpot.

2. The combined vertical greening device of claim 1, wherein, first connecting plates of the left side wall and the right side wall of the first flowerpot, the second connecting plates, third connecting plates of the left side wall and the right side wall of the second flowerpot and the fourth connecting plates are all vertical, a first transverse steel plate is arranged inside the rear side wall of the first flowerpot, one end of the first transverse steel plate is fixedly connected to one of the second connecting plates, and other end of the first transverse steel plate is fixedly connected to other one of the second connecting plates; and a second transverse steel plate is arranged inside the rear side wall of the second flowerpot, one end of the second transverse steel plate is fixedly connected to one of the fourth connecting plates, and other end of the second transverse steel plate is fixedly connected to other one of the fourth connecting plates.

3. The combined vertical greening device of claim 2, wherein, the first flowerpot and the second flowerpot are both formed by pouring of reactive powder concrete; the first connecting plates and the second connecting plates are all partially cast in the first flowerpot; the third connecting plates and the fourth connecting plates are all partially cast in the second flowerpot; a plurality of through holes are formed in each of parts of the first connecting plates and the second connecting plates, which are located in the first flowerpot; a circular hole corresponding to the water inlet of the first flowerpot is formed in one of the second connecting plates; a circular hole corresponding to the drainage hole of the first flowerpot is formed in other one of the second connecting plates; a plurality of through holes are formed in each of parts of the third connecting plates and the fourth connecting plates, which are located in the second flowerpot; a circular hole corresponding to the water inlet of the second flowerpot is formed in one of the fourth connecting plates; and a circular hole corresponding to the drainage hole of the second flowerpot is formed in other one of the fourth connecting plates.

4. The combined vertical greening device of claim 1, wherein, the bottom end of the first connecting plate is fixedly connected to the top end of the third connecting plate at corresponding side wall of the second flowerpot through a first connecting block; the first connecting plate and the third connecting plate are connected to the first connecting block respectively by bolts; the bottom end of each of the second connecting plates is fixedly connected to the top end of corresponding one of the fourth connecting plates through a second connecting block; and the each of second connecting plates and the corresponding one fourth connecting plate are connected to the second connecting block respectively by bolts.

5. The combined vertical greening device of claim 4, wherein, the first connecting plates, the second connecting plates, the third connecting plates and the fourth connecting plates are all steel plates, and the first connecting blocks and the second connecting blocks are all steel blocks.
